(19) United States
(12) Patent Application Publication
(10) Pub. No.: US 2024/0003310 A1
(43) Pub. Date: Jan. 4, 2024

(54) APPARATUS FOR CORRECTING A TORQUE MODEL OF A SPARK IGNITION ENGINE AND A METHOD THEREOF

(71) Applicants: HYUNDAI MOTOR COMPANY, Seoul (KR); KIA CORPORATION, Seoul (KR)

(72) Inventors: Seungmok Choi, Seoul (KR); Hyuk Im, Suwon-si (KR); Jinnam Kim, Gunpo-si (KR); Youngwan Chae, Seoul (KR)

(73) Assignees: HYUNDAI MOTOR COMPANY, Seoul (KR); KIA CORPORATION, Seoul (KR)

(21) Appl. No.: 17/976,158

(22) Filed: Oct. 28, 2022

(30) Foreign Application Priority Data
May 24, 2022 (KR) 10-2022-0063651

(51) Int. Cl. F02D 41/22; F02P 5/153; F02P 5/15

(52) U.S. Cl. CPC F02D 41/22; F02D 2200/024; F02P 5/1502; F02P 5/153

(57) ABSTRACT

An apparatus for correcting a torque model of a spark ignition engine and a method thereof are disclosed. The apparatus includes: a driving information detecting unit which detects engine information and environment information of a vehicle, a combustion pressure sensor which measures a combustion pressure inside a cylinder of an engine, and a controller controlling the engine. In particular, the controller controls the engine based on a pre-stored HR50 (heat release 50%)-based torque model according to whether the combustion pressure sensor of the engine is abnormal or based on an ignition timing-based torque model corrected based on the combustion pressure detected by the combustion pressure sensor with respect to a pre-stored ignition timing-based torque model.

### CROSS-REFERENCE TO RELATED APPLICATION

This application claims priority to and the benefit of Korean Patent Application No. 10-2022-0063651 filed in the Korean Intellectual Property Office on May 24, 2022, the entire contents of which are incorporated herein by reference.

### BACKGROUND

### (a) Field

The present disclosure relates to an apparatus for correcting a torque model of a spark ignition engine and a method thereof.

### (b) Related Art

In general, internal combustion engines, particularly, gasoline engines, operated by an ignition device are controlled using a torque model.

The torque model includes an output torque of an engine according to an ignition timing of the engine. In other words, the torque model has an efficiency curve including an output torque according to delay of an ignition timing based on a maximum torque output from the engine.

When a driver's required torque is input while a vehicle is driving, an engine ignition timing and an amount of air are determined based on a predetermined torque model, and an engine torque is output according to the ignition timing and the amount of air.

Since the torque model of the related art is determined based on the ignition timing of the engine, it is desired to perform correction reflecting various factors, such as an air fuel ratio (AFR) caused by a difference in the combustion speed depending on operating conditions of the engine, a flow rate of an EGR gas supplied to the engine due to the use of an exhaust gas recirculation device, and the like.

In other words, according to the related art, since ignition efficiency of the torque model is changed according to the operating conditions of the engine, it is difficult to accurately control the torque of the engine.

The above information disclosed in this Background section is only to enhance understanding of the background of the present disclosure, and therefore it may contain information that does not form the related art that is already known to a person of ordinary skill in the art.

### SUMMARY

The present disclosure provides an apparatus for correcting a torque model of a spark ignition engine and a method thereof having advantages of improving the accuracy of a torque model based on an ignition timing.

In one embodiment of the present disclosure, an apparatus for correcting a torque model of a spark ignition engine includes: a driving information detecting unit configured to detect engine information and environment information of a vehicle; and a combustion pressure sensor measuring a combustion pressure inside a cylinder of an engine. The apparatus further includes: a controller configured to control the engine based on a pre-stored HR50 (heat release 50%)-based torque model according to whether the combustion pressure sensor of the engine is abnormal. The controller is further configured to control the engine based on an ignition timing-based torque model corrected based on the combustion pressure detected by the combustion pressure sensor with respect to a pre-stored ignition timing-based torque model.

The controller may control the engine based on the HR50-based torque model when the combustion pressure sensor is normal, and control the engine based on the corrected ignition timing-based torque model when the combustion pressure sensor is abnormal.

When an engine operating condition and an environmental condition set based on the engine information and the environment information detected by the driving information detecting unit are satisfied, the controller corrects a reference torque, a reference ignition timing, and an efficiency curve in an ignition timing-based torque model stored in advance based on the combustion pressure detected by the combustion pressure sensor.

Within a maximum brake torque (MBT) operating range, a measured torque calculated as an indicated mean effective pressure (IMEP) of the combustion pressure measured by the combustion pressure sensor may be corrected to the reference torque.

Within the MBT operating range, the crank angle at HR50 (heat release 50%) calculated from the combustion pressure measured by the combustion pressure sensor may be corrected to the reference ignition timing.

The MBT operating range may refer to a case in which HR50 (heat release 50%) calculated from the combustion pressure measured by the combustion pressure sensor is within a set crank angle range.

In another embodiment of the present disclosure, a method for correcting a torque model of a spark ignition engine includes: determining whether a combustion pressure sensor is abnormal; and controlling the engine based on a pre-stored HR50 (heat release 50%)-based torque model according to whether the combustion pressure sensor of the engine is abnormal or controlling the engine based on an ignition timing-based torque model corrected based on the combustion pressure detected by the combustion pressure sensor with respect to a pre-stored ignition timing-based torque model.

When the combustion pressure sensor is normal, the engine is controlled based on the HR50-based torque model, and when the combustion pressure sensor is abnormal, the engine may be controlled based on the corrected ignition timing-based torque model.

The controlling of the engine based on the corrected ignition timing-based torque model may include: detecting driving information by a driving information detecting unit; measuring a pressure inside the cylinder of the engine by the combustion pressure sensor; and determining, by a controller, whether an engine driving condition and an environmental condition are satisfied based on the driving information detected by the driving information detecting unit. The method further includes when the engine operating condition and the environmental condition are satisfied, correcting, by the controller, the reference torque, the reference ignition timing, and the efficiency curve of the torque model stored in advance based on the combustion pressure measured by the combustion pressure sensor.

Within an MBT operating range, a measured torque calculated as an indicated mean effective pressure (IMEP) of the combustion pressure measured by the combustion pressure sensor may be corrected to the reference torque.

The MBT operating range may refer to a case in which HR50 (heat release 50%) calculated from the combustion pressure measured by the combustion pressure sensor is within a set crank angle range.

Within the MBT operating range, the crank angle at HR50 (heat release 50%) calculated from the combustion pressure measured by the combustion pressure sensor may be corrected to the reference ignition timing.

According to the apparatus for correcting a torque model of a spark ignition engine and the method thereof according to the embodiments of the present disclosure as described above, errors may be reduced through the accurate torque model by correcting the torque model using the combustion pressure measured by the combustion pressure sensor.

In addition, by improving the accuracy of the torque model, drivability and cooperative control with other systems may be improved.

### BRIEF DESCRIPTION OF THE DRAWINGS

These drawings are for reference in describing embodiments of the present disclosure, and the technical spirit of the present disclosure should not be construed as being limited to the accompanying drawings.

FIG. 1 is a block diagram illustrating a configuration of an apparatus for correcting a torque model of a spark ignition engine according to an embodiment of the present disclosure.

FIGS. 2 and 3 are flowcharts illustrating a method for correcting a torque model of a spark ignition engine according to an embodiment of the present disclosure.

FIG. 4 is a graph illustrating a torque model according to an embodiment of the present disclosure.

FIG. 5 is a graph for explaining HR50 according to an embodiment of the present disclosure.

FIG. 6 is a graph illustrating torque model correction according to an embodiment of the present disclosure.

FIG. 7 is a graph illustrating an indicator diagram of an engine according to an embodiment of the present disclosure.

### DETAILED DESCRIPTION

Embodiments of the present disclosure are described in detail below with reference to the accompanying drawings so that those having ordinary skill in the art to which the present disclosure pertains can easily carry out the embodiments. The present disclosure may be embodied in many different forms and is not limited to the embodiments described herein.

The drawings and description are to be regarded as illustrative in nature and not restrictive, and like reference numerals designate like elements throughout the present disclosure.

In the drawings, sizes and thickness of components are arbitrarily shown for the description purposes, so the present disclosure is not limited to the illustrations of the drawings and thicknesses are exaggerated to clearly express various parts and regions.

When a component, device, element, or the like of the present disclosure is described as having a purpose or performing an operation, function, or the like, the component, device, or element should be considered herein as being “configured to” meet that purpose or to perform that operation or function.

Hereinafter, an apparatus for correcting a torque model of a spark ignition engine according to an embodiment of the present disclosure is described in detail with reference to the accompanying drawings.

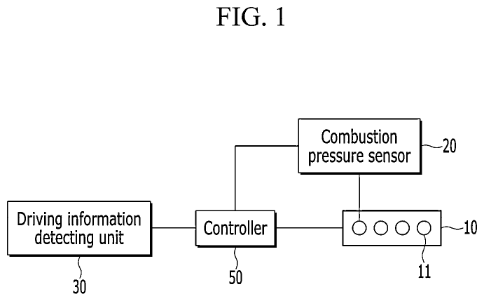

FIG. 1 is a block diagram illustrating a configuration of an apparatus for correcting a torque model of a spark ignition engine according to an embodiment of the present disclosure.

As shown in FIG. 1, the apparatus for correcting a torque model of a spark ignition engine may include a driving information detecting unit 30, a combustion pressure sensor 20, and a controller 50.

The driving information detecting unit 30 detects driving information desired for driving a vehicle, and the detected driving information is transmitted to the controller 50.

The driving information detected by the driving information detecting unit 30 may include engine information and environment information. The engine information may include a speed of the engine 10, the amount of air supplied to the engine 10, a coolant temperature, an air-fuel ratio, and an exhaust gas recirculation (EGR) flow rate. The environment information may include atmospheric pressure, outside air temperature, and outside air humidity.

In one embodiment, the driving information detecting unit 30 may include a speed sensor detecting a speed of the engine 10, an intake air flow sensor (e.g., air flow meter (AFM)) detecting the amount of air, a coolant temperature sensor detecting a coolant temperature, and a flow rate sensor detecting an EGR flow rate.

In addition, the driving information detecting unit 30 may include a pressure sensor detecting atmospheric pressure, an outdoor temperature sensor detecting the outside temperature, and an outdoor humidity sensor detecting humidity of the outside air.

The combustion pressure sensor 20 measures a combustion pressure in each cylinder of the engine 10, and the measured combustion pressure is transmitted to the controller 50.

The controller 50 controls the engine 10 based on a pre-stored HR50 (heat release 50%)-based torque model calculated from the combustion pressure of the engine or controls the engine 10 based on a pre-stored ignition timing-based torque model.

In the embodiment of the present disclosure, the controller 50 controls the engine 10 based on the pre-stored HR50 (heat release 50%)-based torque model or the pre-stored ignition timing-based torque model according to whether the combustion pressure sensor 20 is abnormal. In one embodiment, if the combustion pressure sensor 20 is normal, the controller 50 controls the engine 10 based on the pre-stored HR50 (heat release 50%)-based torque model, and if the combustion pressure sensor 20 is abnormal, the controller 50 controls the engine 10 based on the ignition timing-based torque model.

Also, the controller 50 determines whether an engine operating condition and an environmental condition for correcting the ignition timing-based torque model are satisfied based on the driving information detected by the driving information detecting unit 30. When the engine operating condition and the environmental condition are satisfied, the controller 50 corrects the pre-stored ignition timing-based torque model based on the combustion pressure measured by the combustion pressure sensor 20.

The controller 50 may be implemented through an engine control unit (ECU) or an engine management system (EMS) mounted in the vehicle to control the engine 10.

In one form, the controller 50 may include one or more processors configured to operate according to a set program, and the set program is configured to perform each step of the method for correcting a torque model of the engine 10 according to an embodiment of the present disclosure.

Hereinafter, a method for correcting a torque model of the engine 10 according to an embodiment of the present disclosure is described in detail with reference to the accompanying drawings.

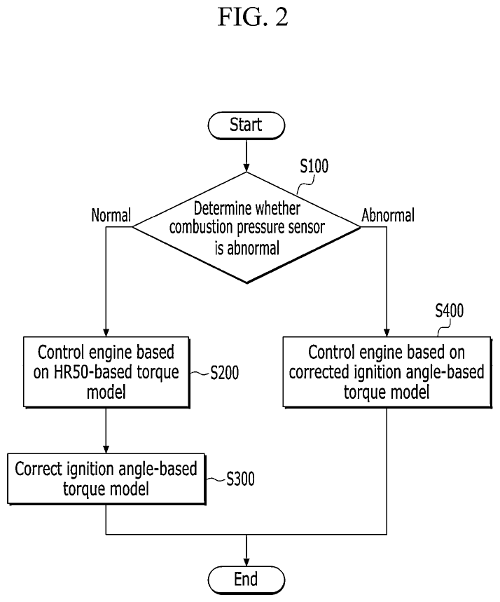

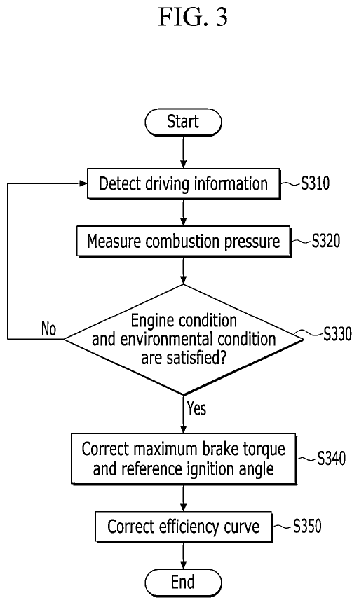

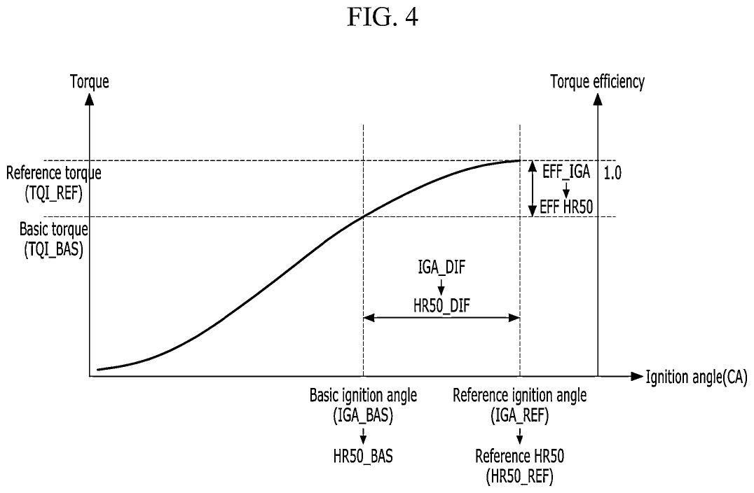

FIGS. 2 and 3 are flowcharts illustrating a method for correcting a torque model of the engine 10 according to an embodiment of the present disclosure. FIG. 3 is a flowchart specifically illustrating step S300 shown in FIG. 2. FIG. 4 is a graph illustrating a torque model according to an embodiment of the present disclosure.

As shown in FIG. 2, the controller 50 determines whether the combustion pressure sensor 20 is abnormal (S100). The controller 50 may determine whether the combustion pressure sensor 20 is abnormal based on a signal output from the combustion pressure sensor 20. For example, if the signal output from the combustion pressure sensor 20 is within a set range, the combustion pressure sensor 20 may be determined as being normal. In addition, if the signal output from the combustion pressure sensor 20 is out of the set range or if no signal is output from the combustion pressure sensor 20, the combustion pressure sensor 20 may be determined as being abnormal.

If there is no abnormality in the combustion pressure sensor 20 (or when the combustion pressure sensor 20 operates normally), the controller 50 controls the engine based on the HR50-based torque model (S200).

As mentioned above, in the embodiment of the present disclosure, the ignition timing-based torque model and the HR50-based torque model are pre-loaded in the controller 50.

Referring to FIG. 4, the torque model is configured as an efficiency curve illustrating torque output from the engine 10 according to ignition timings after setting an engine speed and the amount of air supplied to the engine 10 to certain values and then normalizing the engine torque output at a reference ignition timing to 1.

In the torque model of FIG. 4, the horizontal axis represents an ignition timing (IGA) of the engine 10, the left vertical axis represents torque of the engine 10, and the right vertical axis represents torque efficiency of the engine 10.

In the torque model, a crank angle at which a maximum brake torque (MBT) is output from the engine 10 is a reference ignition timing IGA_REF, and since the maximum brake torque (MBT) is output at the reference ignition timing IGA_REF, the efficiency of the engine 10 at the ignition timing IGA_REF is the highest. Therefore, the efficiency curve is determined by defining the efficiency at the reference ignition timing IGA_REF at which the torque of the engine 10 is maximized, as 1, and then normalizing the torque output from the engine 10 while gradually delaying the ignition timing.

The torque model based on the ignition timing is developed based on standard environmental conditions in a steady state using a dynamometer in a test cell of the engine and stored in advance in the controller 50 of the vehicle.

In other words, the torque model based on the ignition timing includes a reference ignition timing, a reference torque at the reference ignition timing, and an efficiency curve. The basic ignition timing IGA_BAS refers to an actual ignition timing under standard operating conditions, and a basic torque TQI_BAS at the basic ignition timing IGA_BAS is calculated by multiplying the reference torque TQI_REF by the ignition timing-torque efficiency EFF_IGA.

In addition, the HR50-based torque model may be implemented by changing an ignition timing-related factor to an HR50-related factor in the same structure as the ignition timing-based torque model.

For example, in the ignition timing-based torque model, the reference ignition timing IGA_REF is substituted with the reference HR50 HR50_REF, and the basic ignition timing IGA_BAS is substituted with the basic HR50 HR50_BAS.

The reference HR50 HR50_REF is a factor corresponding to the reference ignition timing in the ignition timing-based torque model, and the reference HR50 HR50_REF refers to a crank angle when a maximum brake torque MBT is output.

Since the maximum brake torque MBT is output at the reference HR50 HR50_REF, the efficiency of the engine 10 is the highest at the reference HR50 HR50_REF. Therefore, the efficiency curve is determined by defining the efficiency at the reference HR50 HR50_REF at which the torque of the engine 10 is maximized, as “1”, and normalizing the torque output from the engine 10, while gradually delaying the ignition timing.

The torque model based on the HR50 is developed based on standard environmental conditions in a steady state using a dynamometer in a test cell of the engine and is pre-loaded in the controller 50 of the vehicle.

Here, HR50 (heat release 50%) refers to a crank angle at a time when fuel combustion has been performed by 50%. Based on the combustion pressure P measured by the combustion pressure sensor 20, a heat release rate as shown in Equation 1 below is calculated through a combustion chamber volume V and a specific heat ratio γ of a reaction gas according to an engine crank angle, and heat release rates at respective crank angles are accumulated to calculate a total heat release as shown in Equation 2 below. A crank angle at which 50% of the total heat release is obtained is defined as HR50 (see FIG.

$$\begin{matrix}\dot{Q} = \frac{γ}{γ - 1} P \frac{dY}{d θ} + \frac{γ}{γ - 1} V \frac{dP}{d θ} & [ Equation 1 ] \\ HY = {\int }_{{θ}_{1}}^{{θ}_{2}} \dot{Q} ( θ ) d θ & [ Equation 2 ]\end{matrix}$$

In the related art, the engine is controlled by calculating the engine torque based on the ignition timing in the aforementioned ignition timing-based torque model. However, since the ignition timing is a control signal that determines a combustion start time, a difference may occur in the actual combustion speed or a deviation may occur in the torque model if the operating conditions of the engine change.

Meanwhile, since HR50 is the actual combustion state of the engine measured through the combustion pressure sensor, if the reference of the torque model is changed to HR50, instead of the ignition timing, theoretically, an accurate engine torque may be calculated by reflecting the actual torque output from the engine 10 without an error according to the combustion state (or the operating conditions of the engine).

In step S100, when the combustion pressure sensor 20 operates normally, the controller 50 corrects the ignition timing-based torque model at set intervals (S300).

As shown in FIG. 3, the driving information detecting unit 30 detects driving information, and the driving information detected by the driving information detecting unit 30 is transmitted to the controller 50 (S310).

The combustion pressure sensor 20 measures the combustion pressure of the engine 10, and the combustion pressure measured by the combustion pressure sensor 20 is transmitted to the controller 50 (S320).

The controller 50 determines whether an engine driving condition and an environmental condition are satisfied based on the driving information detected by the driving information detecting unit 30 (S330).

When the vehicle runs, the vehicle is operated in a transient state in which an RPM of the engine and the amount of air introduced into the engine change according to the driver's request, and environmental conditions (e.g., atmospheric pressure, outside temperature, humidity, etc.) also change.

However, since the torque model based on the ignition timing of the engine is generally developed based on standard environmental conditions in a steady state using a dynamometer in a test cell of the engine, an actual engine torque is changed due to a deviation of engine control conditions and environmental conditions when the vehicle actually drives. Therefore, before correcting the torque model, it is desired to determine whether an engine driving condition and an environmental condition are satisfied in a driving state of the vehicle.

The engine operating condition may be determined from a state of control factors affecting a combustion speed at the current RPM of the engine and the amount of air.

For example, in order to determine the engine operating condition, the factors may include a variable valve control factor including a timing and/or a lift of an intake and an exhaust valve, a control factor of a variable intake system including flow path control of a variable intake manifold and/or variable intake flow control, and a fuel injection control factor including a charging pressure of intake, an air fuel ratio, an EGR rate, a fuel injection pressure, the number of times of fuel injections, and/or a fuel injection timing.

When the deviation of the actual engine torque for each control factor is within a set range (e.g., 3%), it may be determined that the engine operating condition is satisfied. However, the scope of the present disclosure is not limited thereto, and the set range may be appropriately changed according to the needs of those having ordinary skill in the art.

The environmental conditions may be set to be the same as those in the test cell. For example, if the environmental condition including atmospheric pressure, outside temperature, and humidity are within the set range, it may be determined that the environmental condition is satisfied. However, when a compensation condition of a torque model for an environmental condition is developed during engine development, the torque model may be corrected based on the compensated model torque.

When the engine operating condition and the environmental condition are satisfied, the controller 50 corrects the reference torque TQI_REF of the torque model, the reference ignition timing IGA_REF, and the ignition timing-torque efficiency curve based on the combustion pressure measured by the combustion pressure sensor 20.

When it is determined that the engine operating condition and the environmental condition are satisfied, the controller 50 calculates HR50 through the combustion pressure measured by the combustion pressure sensor 20.

The controller 50 corrects the maximum brake torque and the reference ignition timing based on the combustion pressure measured by the combustion pressure sensor 20 (S340).

Unlike the reference ignition timing IGA_REF that is changed according to the operating conditions, the reference HR50 HR50_REF does not change in the MBT operating range (ATDC 6 to 8) regardless of the operating conditions. Therefore, it is possible to determine whether the MBT driving is performed in the corresponding driving area. The torque model based on HR50 may be used to completely replace the torque model based on the existing ignition timing, or may be used for torque monitoring and correction, while maintaining the existing torque model.

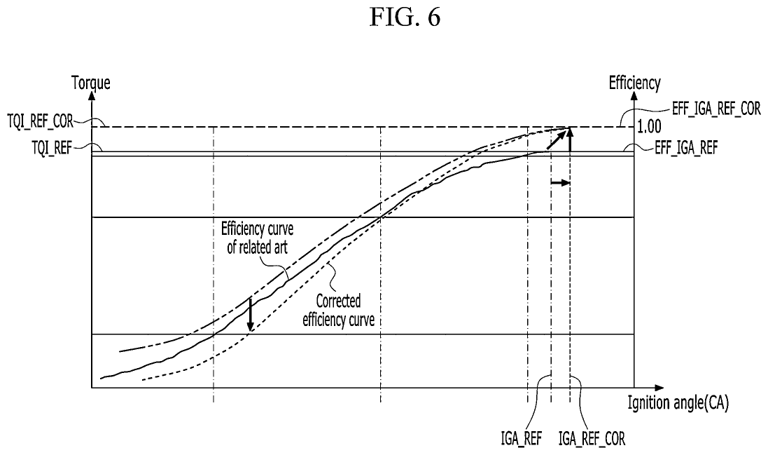

Hereinafter, a method of correcting the reference torque, the reference ignition timing, and the torque efficiency is described with reference to FIG. 6.

### [Reference Torque Correction]

First, the reference torque TQI_REF may be corrected as follows.

When the operating range of the engine is within the MBT operating range (ATDC 6 to 8 degrees), the controller 50 calculates a measured torque from the indicated mean effective pressure (IMEP) of the combustion pressure measured by the combustion pressure sensor 20, and corrects the calculated measured torque to the reference torque.

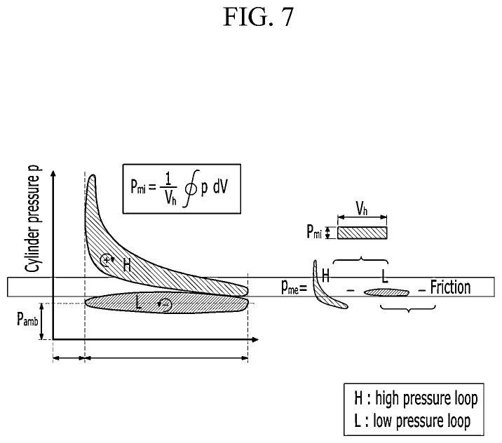

When the combustion pressure is measured by the combustion pressure sensor 20, the indicated mean effective pressure (IMEP) may be calculated (refer to the ‘H’ mark in FIG. 6) by applying a combustion pressure of each cylinder 11 to the indicator diagram (refer to FIG. 7), and the torque may be calculated through the IMEP.

An area of a high pressure loop in the indicator diagram of FIG. 7 refers to work performed in one cylinder 11 per cycle. The area of the high pressure loop may be replaced by a rectangle of the same area. At this time, a length of the horizontal side of the rectangle is the same as a stroke Vh of the corresponding engine, and a length of the vertical side of the rectangle is the IMEP (Pₘᵢ). The IMEP refers to work of a piston per unit volume and is expressed in units of [kPa] or [bar].

In the case of an operating range of the engine other than the MBT (later than ATDC 8 degrees), the controller 50 calculates a measured torque from the indicated mean effective pressure (IMEP) of the combustion pressure measured by the combustion pressure sensor 20 and corrects the calculated measured torque to the reference torque using the efficiency curve of the HR50-based torque model.

For example, the reference torque in an operating range other than the MBT may be calculated through Equations 3 and 4 below.

TQI_REF=TQI_PCYL/EFF_HR50(HR50_DIF) [Equation 3]

HR50_DIF=HR50−HR50_REF [Equation 4]

In the above equations, TQI_REF denotes a reference torque, TQI_PCYL denotes an actual torque measured through the combustion pressure sensor, HR50 denotes a crank angle at a time when fuel combustion has been performed by 50%, and HR50_REF denotes the reference HR50. The HR50 torque efficiency EFF_HR50 is calculated from the HR50_DIF calculated through the efficiency curve stored in the controller 50. That is, in Equation 3, EEF_HR50 is a function using HR50_DIF as a variable.

### [Correction of Reference Ignition Timing]

The reference ignition timing may be corrected as follows.

When the operating range of the engine is within the MBT operating range (ATDC 6 to 8 degrees), the controller 50 corrects the corresponding ignition timing as the reference ignition. In this case, the basic ignition timing IGA_BAS coincides with the reference ignition timing GA_REF.

When the operating range of the engine is out of the MBT operating range (when the ATDC is delayed more than 8 degrees), the actually operating basic ignition timing IGA_BAS is delayed from the reference ignition timing IGA_REF. At this time, the controller 50 corrects the reference ignition timing IGA_REF through the ignition timing efficiency curve so that the HR50 torque efficiency EFF_HR50 is equal to the ignition timing torque efficiency EFF_IGA.

EFF_HR50(HR50_DIF)=EFF_IGA(IGA_DIF) [Equation 6]

HR50_DIF=HR50−HR50_REF [Equation 7]

IGA_REF=IGA+IGA_DIF [Equation 8]

In Equations 6 to 8 above, IGA_DIF for a given EFF_IGA is calculated using an inverse function relationship between the ignition timing difference IGA_DIF and the ignition timing efficiency EFF_IGA stored in the controller 50, and the reference ignition timing IGA_REF is calculated from IGA_DIF and the current ignition timing IGA. That is, EFF_HR50 is a function using HR50_DIF as a variable, and EFF_IGA is a function using IGA_DIF as a variable.

As such, when the reference torque and the reference ignition timing are corrected, as shown in FIG. 6, the reference torque TQI_REF of the related art moves to the corrected reference torque TQI_REF_COR, and the reference ignition timing IGA_REF of the related art moves to the corrected reference ignition timing IGA_REF_COR.

That is, a point where the reference torque TQI_REF and the reference ignition timing IGA_REF of the related art meet moves to a point where the corrected reference torque TQI_REF_COR and the reference ignition timing IGA_REF_COR meet.

Also, a shape of the efficiency curve at this time may maintain the same as the shape of the related art.

### [Correction of Efficiency Curve]

When the reference torque and the reference ignition timing are corrected, the controller 50 corrects the efficiency curve of the torque model based on the reference torque and the reference ignition timing (S350). The torque efficiency curve based on the ignition timing may be stored in advance in the controller 50 as a function according to the ignition timing difference IGA_DIF or in the form of a lookup table.

The efficiency curve of the torque model is corrected by the following process.

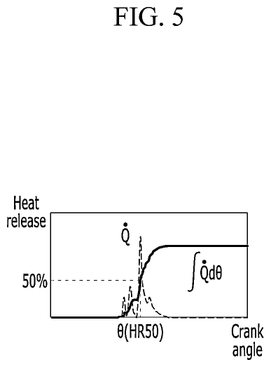

As described above, when the reference torque and the reference ignition timing are corrected in the torque model based on the existing ignition timing, the reference torque TQI_REF and the reference ignition timing IGA_REF in the existing efficiency curve (refer to the efficiency curve of the solid line in FIG. 5) move to the corrected reference torque TQI_REF_COR and the corrected reference ignition timing IGA_REF_COR.

In addition, the efficiency curve (the efficiency curve of the solid line in FIG. 4) formed based on the reference torque TQI_REF and the reference ignition timing IGA_REF of the related art forms the efficiency curve (the efficiency curve of the dotted chain line in FIG. 5) based on the corrected reference torque TQI_REF_COR and the corrected reference ignition timing IGA_REF_COR.

When the corrected reference torque and the corrected reference ignition timing are determined, the controller 50 compares the HR50 reference model torque with the ignition timing reference model torque based on the corrected reference torque and the corrected reference ignition timing. When there is a difference between the HR50 reference model torque and the ignition timing reference model torque, the controller 50 calculates a finally corrected efficiency curve using a value in the lookup table.

As such, when the efficiency curve is corrected, as shown in FIG. 6, the efficiency curve (the efficiency curve of the solid line in FIG. 6) of the related art is corrected to the corrected efficiency curve (the efficiency curve of the dotted line in FIG. 6) based on the corrected reference torque TQI_REF_COR and the reference ignition timing IGA_REF_COR.

In step S100, when the combustion pressure sensor 20 operates abnormally, the controller 50 controls the engine 10 based on the corrected ignition timing-based torque model. That is, when the driver's required torque is input, the controller 50 controls the torque output from the engine 10 by controlling the ignition timing and/or the amount of air of the engine 10 based on the corrected ignition timing-based torque model.

As such, when the torque model of the engine 10 is corrected (or learned), the controller 50 controls the output torque of the engine 10 by controlling the ignition timing and/or the amount of air of the engine 10 using the learned (or corrected) ignition timing-based torque model.

According to the apparatus for correcting the torque model of the engine 10 and the method thereof according to the embodiments of the present disclosure as described above, the engine is controlled based on the HR50-based torque model or the corrected ignition timing-based torque model according to whether the combustion pressure sensor operates normally.

Since the HR50-based torque model may obtain a constant torque efficiency curve regardless of the engine operating condition, an engine torque deviation according to the operating condition may be improved.

In addition, by providing the ignition timing-based torque model corrected based on the combustion pressure, while the combustion pressure sensor is operating normally, there is no need to perform separate correction according to the operating conditions of the engine 10. In addition, since the deviation for each part that occurs according to a continuous operation of the engine 10 is reflected in the corrected torque model, the corrected torque model may be used as a reference for calculating the correct engine torque.

Although the embodiments of the present disclosure have been described above, the present disclosure is not limited thereto, and it is possible to carry out various modifications within the claim coverage, the description of the present disclosure, and the accompanying drawings, and such modifications also fall within the scope of the present disclosure.

### DESCRIPTION OF SYMBOLS

10: engine
11: cylinder
20: combust pressure sensor
30: driving information detecting unit
50: controller

What is claimed is:

1. An apparatus for correcting a torque model of a spark ignition engine, the apparatus comprising:
a driving information detecting unit configured to detect engine information and environmental information of a vehicle;
a combustion pressure sensor configured to measure a combustion pressure inside a cylinder of an engine; and
a controller configured to control the engine based on a pre-stored HR50 (heat release 50%)-based torque model according to whether the combustion pressure sensor of the engine is abnormal, or configured to control the engine based on an ignition timing-based torque model corrected based on the combustion pressure detected by the combustion pressure sensor with respect to a pre-stored ignition timing-based torque model.

2. The apparatus of claim 1, wherein the controller is configured to:
control the engine based on the pre-stored HR50-based torque model when the combustion pressure sensor is normal, and
control the engine based on the corrected ignition timing-based torque model when the combustion pressure sensor is abnormal.

3. The apparatus of claim 1, wherein when an engine operating condition and an environmental condition set based on the engine information and the environmental information detected by the driving information detecting unit are satisfied, the controller is configured to correct a reference torque, a reference ignition timing, and an efficiency curve in an ignition timing-based torque model stored in advance based on the combustion pressure detected by the combustion pressure sensor.

4. The apparatus of claim 3, wherein within a maximum brake torque (MBT) operating range, a measured torque calculated as an indicated mean effective pressure (IMEP) of the combustion pressure measured by the combustion pressure sensor is corrected with the reference torque.

5. The apparatus of claim 3, wherein within a maximum brake torque (MBT) operating range, a crank angle at HR50 (heat release 50%) calculated from the combustion pressure measured by the combustion pressure sensor is corrected to a reference ignition timing.

6. The apparatus of claim 4, wherein the MBT operating range refers to a case in which HR50 (heat release 50%) calculated from the combustion pressure measured by the combustion pressure sensor is within a set crank angle range.

7. A method for correcting a torque model of a spark ignition engine, the method comprising:
determining, by a controller, whether a combustion pressure sensor is abnormal; and
controlling, by the controller, the engine based on a pre-stored HR50 (heat release 50%)-based torque model according to whether the combustion pressure sensor of the engine is abnormal or based on an ignition timing-based torque model corrected based on the combustion pressure detected by the combustion pressure sensor with respect to a pre-stored ignition timing-based torque model.

8. The method of claim 7, wherein:
when the combustion pressure sensor is normal, the engine is controlled based on the pre-stored HR50-based torque model, and
when the combustion pressure sensor is abnormal, the engine is controlled based on the corrected ignition timing-based torque model.

9. The method of claim 7, wherein controlling the engine based on the corrected ignition timing-based torque model includes:
detecting driving information by a driving information detecting unit;
measuring a pressure inside of a cylinder of the engine by the combustion pressure sensor;
determining, by the controller, whether an engine driving condition and an environmental condition are satisfied based on the driving information detected by the driving information detecting unit; and
when the engine driving condition and the environmental condition are satisfied, correcting, by the controller, a reference torque, a reference ignition timing, and an efficiency curve of the torque model stored in advance based on the combustion pressure measured by the combustion pressure sensor.

10. The method of claim 9, wherein within a maximum brake torque (MBT) operating range, a measured torque calculated as an indicated mean effective pressure (IMEP) of the combustion pressure measured by the combustion pressure sensor is corrected to the reference torque.

11. The method of claim 9, wherein a maximum brake torque (MBT) operating range refers to a case in which HR50 (heat release 50%) calculated from the combustion pressure measured by the combustion pressure sensor is within a set crank angle range.

12. The method of claim 11, wherein within the MBT operating range, the crank angle at HR50 (heat release 50%) calculated from the combustion pressure measured by the combustion pressure sensor is corrected to the reference ignition timing.
